(19) United States
(12) Patent Application Publication
(10) Pub. No.: US 2004/0095390 A1
(43) Pub. Date: May 20, 2004

(54) Method of performing a drag-drop operation

(75) Inventors: Andreas Arning, Tuebingen (DE); Frank Leymann, Aidlingen (DE); Dieter Roller, Schoenaich (DE); Roland Seiffert, Herrenberg (DE)

Correspondence Address: Marilyn Dawkins, International Business Machines, Intellectual Property Law, 11400 Burnet Road, Austin, TX, 78758, US

(73) Assignee: INTERNATIONAL BUSINESS MACHINES CORPORATON, ARMONK, NY (US)

(21) Appl. No.: 10/702,991

(22) Filed: Nov. 6, 2003

(30) Foreign Application Priority Data
Nov. 19, 2002 (DE) 02025846.3

(51) Int. Cl. G09G 5/00

(52) U.S. Cl. 345/769

(57) ABSTRACT

The invention relates to a method of performing a drag-and-drop operation of an object onto a container of a set of containers, the method comprising the steps of:

selecting the object,

drag-and-drop of the selected object onto a first container of the set of containers,

prediction of a second container of the set of containers to which the object is assigned,

if the second container is different from the first object, outputting of a warning signal.

### FIELD OF THE INVENTION

The present invention generally relates to computer graphical user interfaces. More specifically, the invention relates to performing of a drag-and-drop operation of files onto a folder by means of a graphical user interface (GUI).

### BACKGROUND AND PRIOR ART

In GUI environments, files are handled basically with the use of a mouse, and almost all operations can be performed with the mouse. In an operating system based on a GUI environment, for example, in Windows (trademark of Microsoft Corporation, U.S.A., registered in the United States and other countries), file handling by means of drag-and-drop is available.

A selected file may be dragged and dropped onto an icon of a folder on the desktop or in a file tree. Also, dropping the selected file onto an icon representing a folder permits the dragged file to be copied/moved to that folder.

A common disadvantage of prior art GUIs is that there is a certain risk of misplacing a file in the wrong folder by inadvertently releasing the left mouse button during a drag-and-drop operation.

It is therefore an object of the present invention to provide for an improved method of performing a drag-and-drop operation and a corresponding computer program product and data processing system.

### SUMMARY OF THE INVENTION

The method provides for an improved method of performing a drag-and-drop operation of an object, such as a file, onto an container, such as a folder, of a set of containers, whereby a prediction is performed whether the folder onto which the file is dropped is the folder to which the file is actually assigned, or whether the drop operation is performed accidentally. This way it is checked whether the drop of the file onto the folder is plausible or whether the drop operation is likely to be performed inadvertently by the user.

If it turns out that the folder onto which the file is dropped is likely not to be the correct folder a warning signal is generated and outputted to the user. This enables a user to check whether the folder on which he or she has dropped the file is the correct folder or not. This way misplacing of files into the wrong folders is avoided.

In accordance with a preferred embodiment of the invention the prediction is performed based on a data mining model. The data mining model is established based on a set of folders, such as the folders of a folder tree. For example Microsoft Explorer can be used to provide such a folder tree.

The folders of the folder tree typically are not empty but contain related files, such as text documents or other data, relating to the same or similar subjects. The existing set of folders with files in them forms the basis for establishing a data mining model. To establish a data mining model any suitable prior art data mining method can be used such as the IBM™ product “DB2 Intelligent Miner for Text”, or the IBM™ product “DB2-Intelligent Mining for Data”, both products being available at each IBM business partner and publicly available under http://www.ibm.com/software/data/iMiner/. Also other IBM products from the Intelligent Miner family or other prior art data mining methodologies can be used for the purpose of establishing a data mining model on the basis of the set of folders with files in them.

In accordance with a preferred embodiment of the invention a confidence value is calculated for the file which is dropped onto a folder. The confidence value provides a measure as to the credibility of the prediction of a folder of the set of folders to which the file is assigned.

Preferably this confidence value is only calculated in case the predicted folder and the folder onto which the file is dropped are not the same. The warning signal is outputted only if the confidence value is above a certain threshold value. The threshold value can be a fixed value or a user selected value. This means that only if the prediction of an alternative folder other than the folder onto which the file is dropped by the user has a certain minimum credibility, a warning signal is generated and outputted.

In accordance with a further preferred embodiment of the invention topological information of the placement of the folders on the GUI is evaluated for the purpose of modifying the confidence value. The heuristics behind this is that if a user drops the file onto a folder and the prediction indicates that a folder next to the folder onto which the file is dropped is likely to be the correct folder, this prediction is more likely to be accurate compared to a situation where a folder which is distant from the folder onto which the file is dropped is predicted to be the accurate folder. Usually a user will only misplace the file into folders which are in the close proximity of the correct folder. The confidence value which is calculated based on the data mining model is modified accordingly.

For example the distance between the folder onto which the file is dropped and the predicted folder is measured in terms of the number of folders being between the folder onto which the file is dropped and the predicted folder within the folder tree on the path linking these folders.

In accordance with a preferred embodiment of the invention the confidence value is divided by the number of folders within that path or by the square root of that number.

In accordance with a further preferred embodiment of the invention only a sub-set of folders in the close proximity of the folder onto which the file is dropped is considered for the purpose of performing the prediction. This is based on the assumption that a user would only misplace a file on a folder which is in the close proximity of the accurate folder within the file tree.

In accordance with a further preferred embodiment of the invention a plausibility check is also made whether the selection of the file is accurate in addition to or as an alternative to performing a plausibility check regarding the correctness of the folder onto which the selected file is dropped. This is particularly advantageous when the file is selected from a list of files, such as the email messages in the inbox or outbox folder of an email program.

Further the invention provides for a corresponding computer program product, such as a digital storage medium for performing the present invention and a data processing system, such as a personal computer, incorporating the present invention. For example, the methods of the invention can be implemented into a data processing system, such as a personal computer, by means of an application programme running in the background or as a part of the operating system of the computer itself.

### BRIEF DESCRIPTION OF THE DRAWINGS

In the following preferred embodiments of the invention will be described in greater detail by making reference to the drawings in which:

FIG. 1 is illustrative of a flow chart for establishing a data mining model for a set of folders.

FIG. 2 is illustrative of a flow chart of an embodiment for performing a drag-and-drop operation in accordance with the present invention.

FIG. 3 is a block diagram of an embodiment of a data processing system of the present invention.

### DETAILED DESCRIPTION

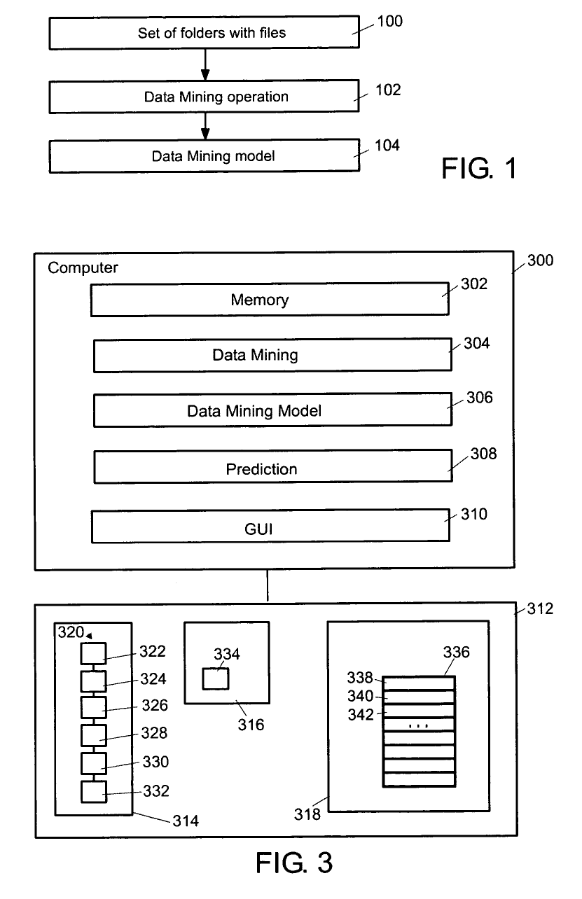

FIG. 1 shows a flow diagram illustrating the generation of a data mining model. In step 100 a set of folders is provided, such as the folders contained in a folder tree. For example the folder tree is provided by the Microsoft Explorer program. The folders in the folder tree contain files which are somehow related by subject, i.e. each of the folders relates to a certain subject and contains files being related to that subject.

In step 102 a data mining operation is performed on the set of folders with files in them provided in step 100. This data mining operation can be performed by means of an IBM product of the Intelligent Miner family or by means of another suitable data mining program.

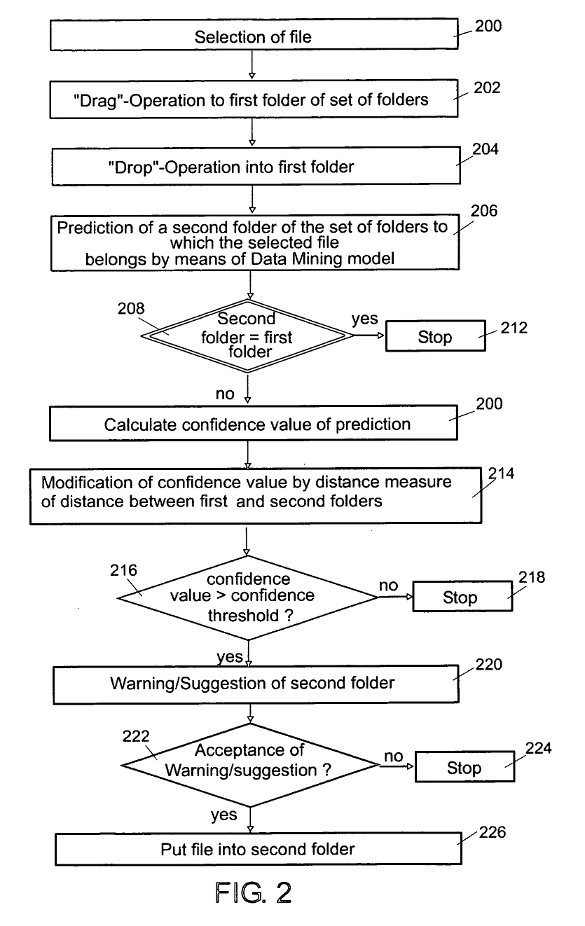

By means of a data mining operation performed in step 102 a data mining model of the set of folders is provided in step 104. This data mining model is used for the purposes of performing plausibility checks as it will be explained in more detail with reference to FIG. 2. It is preferred that the method of FIG. 1 is performed repetitively for updating the data mining model at pre-defined time intervals or each time data is added or removed from the set of folders.

FIG. 2 is illustrative of a flow chart for performing a drag-and-drop operation with a plausibility check. In step 200 a file is selected by a user. Preferably this is done by clicking on an icon which represents the file with a computer mouse. In step 202 the selected file is moved to a first folder of a set of folders by means of a drag-operation.

This is performed by means of the GUI while keeping the left mouse button pushed down. Alternatively this operation can also be performed by means of a track ball or a similar device. Preferably the set of folders is visualised on the GUI in the form of a folder tree, such as by a Microsoft Explorer tree. The set of folders contained in the Explorer tree is the same set of folders for which the data mining model has been established (steps 100 to 104 of FIG. 1).

After the icon representing the selected file has been dragged to the first folder a drop-operation is performed in step 204 by releasing the left mouse button.

In step 206 the plausibility of this drag-and-drop operation of the selected file onto the first folder is checked. This is done by using the data mining model to predict the folder of the set of folders which is assigned to the selected file. When the predicted second folder is the same as the first folder (step 202), this means that the drag-and-drop operation performed by the user is likely to be accurate and that it is correct to put the selected file into the first folder. In this case the method stops in step 210.

If the second folder and the first folder are not the same this means that there is a certain degree of likelihood that the first folder onto which the selected file is dragged and dropped is in fact not the correct folder. In this instance a confidence value of the prediction performed in step 206 is calculated in step 212. Depending on the kind of data mining model which is used in step 206 a separate calculation of the confidence value in step 212 might not be required as the confidence value is already determined by performing the prediction in step 206.

In step 214 the topology of the folder tree is taken into consideration. This is done by determining a distance between the first and the second folders within the folder tree. For example, the first and the second folders are linked by a path within the folder tree. The length of this path in terms of the number of folders which are contained in the path can be used as a distance measure.

This distance measure is used in order to modify the confidence value and to thereby take into consideration the topology of the folder tree for the plausibility check. Preferably the modification of the confidence value by the distance measure is done by dividing the confidence value by the distance or by the square root of the distance.

This means that if the second folder has a relatively high confidence value as determined in step 212 but is very distant from the first folder, the confidence value is decreased correspondingly. This way a high confidence value can be transformed to a low confidence value due to the fact that there is a large distance between the first and the second folders and that it is therefore not plausible that the user has inadvertently dragged the selected file to the first folder instead of to the second folder. Likewise, if the second folder is next to the first folder the distance is equal to 1 and the confidence value remains unchanged.

Preferably only second folders which are in the proximity of the first folder are considered for the purposes of performing the plausibility check. This way second folders which are too remote from the first folder to be likely targets of the intended drag-and-drop operation are filtered out from the beginning.

In step 216 the modified confidence value obtained in step 214 is compared against the confidence threshold value. If the confidence value does not surpass the confidence threshold the control stops in step 218. In the opposite case a warning signal is generated in step 220. For example a warning message comes up on the GUI and informs the user that the second folder is likely to be the correct folder. Further, the confidence value can be shown in the warning message.

When the user accepts the warning message and the suggested second folder (step 222) the selected file which had been dragged to the first folder is moved into the second folder in step 226. If the user declines the warning message the control stops in step 224.

FIG. 3 shows a corresponding data processing system. The data processing system has a computer 300, such as a personal computer. The computer 300 has a working memory 302. Further the computer 300 has a data mining program 304 such as a program from the IBM Intelligent Miner family. Data mining program 304 serves to generate data mining model 306 for the data storage in memory 302.

Further the computer 300 has a prediction program 308 and a graphical user interface (GUI) 310.

Computer 300 is coupled to display unit 312. Display unit 312 shows the windows 314, 316 and 318.

Window 314 shows a file tree 320 containing folders 322, 324, 326, 328, 330, 332. In a practical application file tree 320 may contain a larger number of folders.

Window 316 shows an icon 334 representing a file, such as a text document or a spreadsheet.

Window 318 belongs to an email program and shows an inbox 336 of the email program containing email messages 338, 340, 342, . . . which have been received by a user.

Each one of the folders 322 to 332 may contain one or more files which are somehow related by subject. These files are stored in memory 302. In operation the data mining program 304 is executed to provide a data mining model 306 for the folders 322 to 332 contained in the file tree 320 and the respective files of these folders.

The user may want to move the file being represented by icon 334 within window 316 to folder 328 of file tree 320 as the content of that file is related to the subject of the folder 328. This is done by clicking on the icon 334 in order to select the file and then moving the icon 334 onto folder 328 while pressing the left mouse button down. When the left mouse button is released while the icon 334 is above the folder 328 the file being represented by the icon 334 is moved from the window 316 into the folder 328.

However, instead of releasing the mouse button when the icon 334 is above folder 328 the user may inadvertently release the left mouse button when the icon 334 is above for example folder 326. In order to prevent misplacing of the file the following operation is performed when the icon 334 is selected and dragged-and-dropped onto one of the folders:

The prediction program 308 is invoked in order to predict a folder of file tree 320 to which the file being represented by icon 334 belongs based on the data mining model 306. If the predicted folder is the same as the one onto which the icon 334 is dropped no further action occurs. If however the predicted folder and the folder onto which the icon 334 is dropped are not the same a warning signal pops up. This enables the user to check whether he or she has performed the drag-and-drop operation accurately or if a correction is required.

Likewise the user can select one of the messaged 338, 340, 342 . . . and move the selected message to one of the folders of file tree 320. To perform a plausibility check, again the prediction program 303 is invoked for predicting a likely folder within file tree 320 to which the selected message belongs.

### List of Reference Numerals

computer 300

memory 302

data mining program 304

data mining model 306

prediction program 308

graphical user interface 310

display unit 312

window 314

window 316

window 318

file tree 320

folder 322

folder 324

folder 326

folder 328

folder 330

folder 332

icon 334

inbox 336

message 338

message 340

message 342

1. A method of performing a drag-and-drop operation of an object onto a container of a set of containers, the method comprising the steps of:
selecting the object,
drag-and-drop of the selected object onto a first container of the set of containers,
prediction of a second container of the set of containers to which the object is assigned,
if the second container is different from the first object, outputting of a warning signal.

2. The method of claim 1 whereby the prediction is influenced by a topology of the set of containers.

3. The method of claims 1 or 2 further comprising performing the prediction based on a data mining model of the set of containers.

4. The method of claims 1, 2 or 3, further comprising the steps of:
calculating a confidence value for the prediction,
outputting of the warning signal only if the confidence value is above a confidence threshold.

5. The method of claim 4, further comprising modifying of the confidence value by a distance measure of a distance between the first and the second containersin a container tree.

6. The method of claim 5, whereby the modification of the confidence value by the distance measure is performed by dividing the confidence value being representative of the distance between the first and the second containers in the container tree.

7. The method of claim 6, whereby the value is the square root of the distance.

8. The method of any one of the preceding claims 1 to 7, whereby the prediction is performed only with respect to a sub-set of the set of containers, the sub-set of containers having containers in the proximity of the first folder.

9. The method of any one of the preceding claims 1 to 8, whereby the object is selected from a container of an email program.

10. A computer program product, in particular a digital storage medium, comprising computer program means for performing the steps of:
prediction of a second container of a set of containers to which an object is assigned, after the object has been moved to the first container of the set of containers by means of a drag-and-drop operation,
outputting of a warning signal, if the second container is different from the first containers.

11. The computer program product of claim 10, the program means being adapted to perform the prediction based on a data mining model of the set of containers.

12. The computer program product of claims 10 or 11, the program means being adapted to perform the steps of calculating a confidence value for the prediction, and outputting of the warning signal only if the confidence value is above a threshold value.

13. A data processing system comprising:
graphical user interface means (310) for selecting of an object,
drag-and-drop means (310) for moving of the selected object onto a first container of a set (320) of containers,
means (304, 306, 308) for performing a prediction of a second container of the set of containers to which the object is assigned,
means (310) for outputting of a warning signal if the second container is different from the first containers.

14. The data processing system of claim 13, the means for performing the prediction being adapted to perform the prediction based on a data mining model (306) of the set of containers.

15. The data processing system of claims 13 or 14 further comprising means (306, 308) for calculating of a confidence value for the prediction, whereby the warning signal is only generated if the confidence value is above a threshold value.
